(19) United States
(12) Patent Application Publication
(10) Pub. No.: US 2004/0200024 A1
(43) Pub. Date: Oct. 14, 2004

(54) Carwash brush

(76) Inventor: Theodore Yamin, Lapeer, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/819,648

(22) Filed: Apr. 7, 2004

Related U.S. Application Data
(60) Provisional application No. 60/461,148, filed on Apr. 8, 2003.

(51) Int. Cl. B60S 3/06

(52) U.S. Cl. 15/230.16; 15/53.2; 15/181

(57) ABSTRACT

A carwash brush having a pair of annular hubs, each hub having a planar annular surface. A plurality of elongated fingers each have a first end sandwiched in between the hubs so that the fingers extend radially outwardly from the hubs and so that the second or outer ends of each finger are circumferentially spaced from each other. The first ends of the fingers are continuously bonded to the hubs. Preferably, both the hubs and the fingers are constructed of a closed-cell foam.

### RELATED APPLICATION

This application claims priority of U.S. Provisional Patent Application Serial No. 60/461,148 filed Apr. 8, 2003, which is incorporated herein by reference.

### BACKGROUND OF THE INVENTION

I. Field of the Invention

The present invention relates to a carwash brush.

II. Description of Related Art

Automatic carwashes typically use rotating brushes to remove dirt and other debris from vehicles as the vehicles pass under or by the rotating brushes. These previously known carwash brushes typically comprise a hub having a plurality of outwardly extending fingers. The hub itself is rotatably driven by a motor while the outwardly extending fingers from the brush contact and remove dirt and other debris from the vehicle.

The fingers of these previously known carwash brushes are constructed of a flexible material and are typically constructed of a fabric material. Furthermore, since it is imperative that the brushes not damage the vehicles as the fingers from the brushes contact the vehicles during the carwash, soft, synthetic material is typically used to form the brushes.

One disadvantage of these previously known carwash brushes, however, is that the hub is exposed to water and debris during the carwash operation. As such, the hub can become saturated with water and debris so that the weight of the hub necessarily increases. When this happens, the increased weight of the hub can cause the hub to contact the vehicle and damage the finish on the vehicle.

A still further disadvantage of these previously known carwash brushes which utilize a fabric material for the fingers is that debris can become embedded within the fabric material of the fingers. In this event, the embedded debris can contact the vehicle during the carwash operation and scratch or otherwise damage the finish on the vehicle.

A still further disadvantage of the previously known carwash brushes is that they are expensive to manufacture.

### SUMMARY OF THE PRESENT INVENTION

The present invention provides a carwash brush which overcomes all of the above-mentioned disadvantages of the previously known carwash brushes.

In brief, the carwash brush comprises a pair of annular hubs wherein each hub includes a planar axial surface. Preferably, each hub is constructed of a one-piece closed-cell synthetic foam.

The carwash brush further includes a plurality of elongated fingers. Each finger has a first end positioned in between the axial surfaces of the hubs so that the first ends of the fingers extend continuously around the hubs. In doing so, the second or outer end of each finger extends radially outwardly from the hub and these second ends of the fingers are circumferentially spaced from each other. Preferably, the fingers are also constructed of a closed-cell synthetic foam.

With the first ends of the fingers sandwiched in between two hubs, the fingers are continuously bonded to the hubs by any conventional means, such as an adhesive, vulcanization, and the like. In doing so, the bond between the first ends of the fingers and the hubs precludes the absorption of water or the accumulation of debris within the hub.

Although the carwash brush of the present invention may comprise a single pair of hubs with a layer of fingers having their first ends sandwiched in between the hubs, more typically the carwash brush includes a plurality of spaced-apart annular hubs with a layer of fingers bonded between each pair of adjacent hubs. In doing so, the carwash brush of the present invention forms a stacked brush of hubs and fingers of any desired height.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a side diagrammatic view illustrating a preferred embodiment of the present invention installed in a carwash;

FIG. 2 is a partial fragmentary plan view of the preferred embodiment of the present invention;

FIG. 3 is an elevational and partial exploded view of the preferred embodiment of the present invention;

FIG. 4 is a fragmentary plan view illustrating a portion of the present invention; and

FIG. 5 is a fragmentary sectional view taken substantially along line 5-5 in FIG. 3 and enlarged for clarity.

### DETAILED DESCRIPTION OF A PREFERRED EMBODIMENT OF THE PRESENT INVENTION

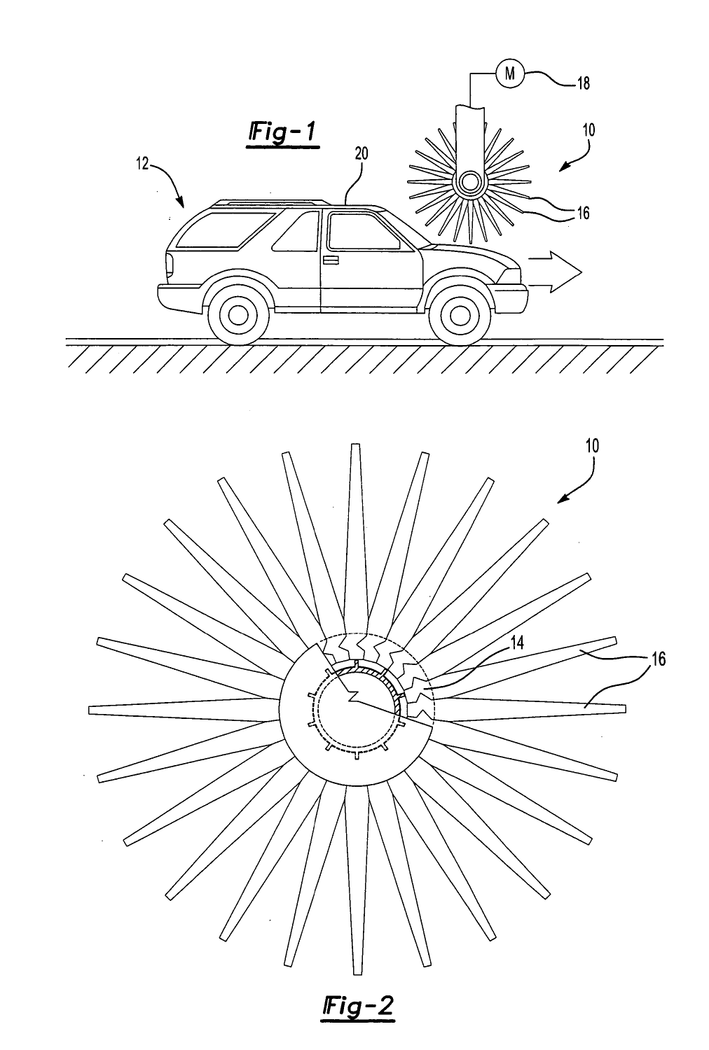

With reference first to FIGS. 1 and 2, a preferred embodiment of the carwash brush 10 of the present invention is shown for use in a carwash 12 (FIG. 1). The carwash brush 10 includes a hub assembly 14 having a plurality of elongated fingers 16 extending radially outwardly and circumferentially spaced around the hub assembly 14. The hub assembly 14 is rotatably driven by a motor 18, illustrated only diagrammatically in FIG. 1, so that the fingers 16 contact a vehicle 20 in the carwash 12 as the vehicle 20 passes under or past the brush 10.

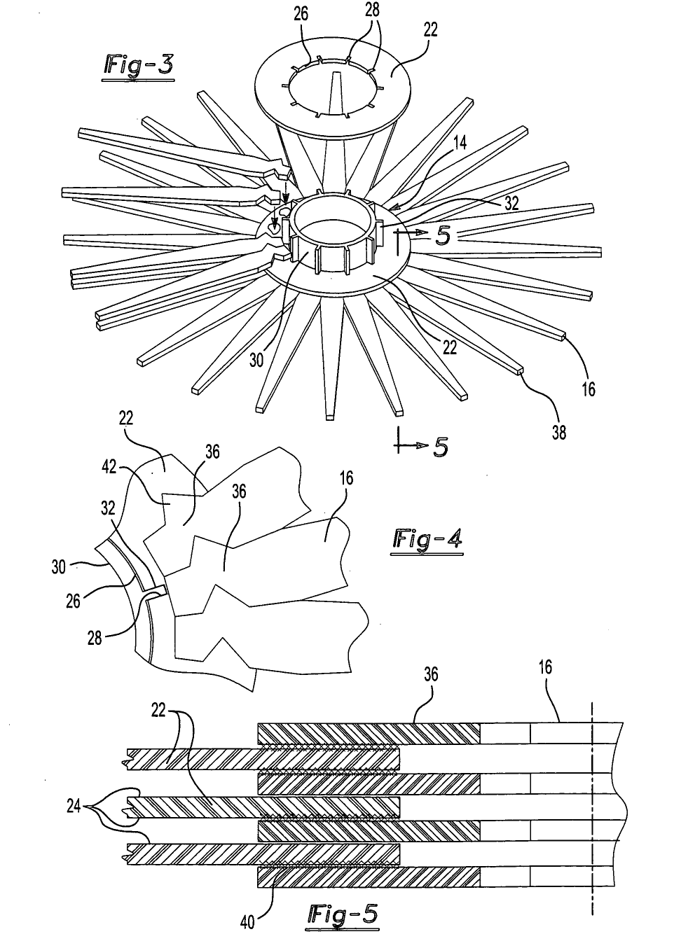

With reference now to FIGS. 3-5, the hub assembly 14 includes a plurality of annular hubs 22 which are spaced apart and generally parallel to each other. Each hub 22 includes opposing planar axial surfaces 24 (FIG. 5) and preferably the hubs 24 are constructed of a synthetic closed-cell foam material.

Each hub 22 includes a throughbore 26 having a plurality of circumferentially spaced and radially outwardly extending slots 28 formed around the opening 26. Although the throughbore 26 is illustrated as circular in shape, it may alternatively be square or diamond-shaped, or any other shape. A drive cylinder 30 includes a plurality of circumferentially and radially outwardly extending drive members 32 which register with and are received within the slots 28 on the hubs 22. Consequently, rotation of the drive cylinder 30 rotatably drives the hubs 22. The motor 18 (FIG. 1) is drivingly connected by any conventional means to rotatably drive the drive cylinder 30.

Each finger 16 includes a first end 36 which is sandwiched in between two adjacent hubs 22. A second or outer end 38 (FIG. 3) of each finger 16 is spaced radially outwardly from the hub assembly 14 so that these outer ends 38 of the fingers 16 are circumferentially equidistantly spaced around the hub assembly 14.

With reference now particularly to FIG. 5, the first end 36 of each finger 16 is continuously bonded to its two adjacent hubs 22 which prevents dirt, water or other debris from accumulating in between the first ends 36 of the fingers 16 and the hubs 22. Preferably, an adhesive layer 40 is provided between the first ends 36 of the fingers 16 and the hubs 22, although other means, such as vulcanization, may alternatively be used to continuously bond the first ends 36 of the fingers 16 to the hubs 22.

Alternatively, two or more layers of fingers 16 may be sandwiched in between two hubs 14.

With reference now particularly to FIG. 4, the first end 36 of each finger 16 includes an outwardly extending projection 42 which extends in a direction circumferential with respect to the axis of the hub assembly 14. Similarly, a complementary shaped recess 44 is formed on the opposite circumferential side of the first end 36 of each finger 16. Thus, with the first ends 36 of the fingers 16 positioned on the hub 22, the projection 42 from the one finger 16 nests within the recess 44 on the adjacent finger 16. In doing so, the inner ends 36 of the fingers 16 form a continuous surface between the hubs 22.

The projections 42 and recesses 44 serve two important functions. First, the mechanical interlock between the projections 42 and recesses 44 strengthens the attachment between the fingers 16 and the hubs 22 against radial centrifugal force during rotation of the brush 10. Additionally, the cooperation between the projections 42 and recesses 44 enables rapid and accurate assembly of the fingers 16 between the hubs 22 and ensures that the fingers 16 are equidistantly spaced around the hubs 22.

The fingers 16 are constructed of any conventional flexible and soft material. However, in the preferred embodiment of the invention, the fingers 16 are constructed of a foam material and are preferably constructed of a synthetic closed-cell foam material.

Although the carwash brush 10 of the present invention may be constructed using only a pair of hubs 22 with a single layer of fingers 16 sandwiched in between the two hubs 22, more typically the brush 10 is constructed from a plurality of axially spaced hubs 22 with a layer of fingers 16 sandwiched in between each pair of adjacent hubs 22 as best shown in FIG. 5 of the drawing. With this construction, the axial length of the overall brush 10 may be varied as required for the particular carwash installation by merely varying the number of layers of hubs 22 and fingers 16.

A primary advantage of the brush 10 of the present invention is that, since the first ends 36 of the fingers 16 are continuously bonded to the hubs 22, dirt and other debris cannot accumulate within the hub assembly 14. Furthermore, since the fingers 16 as well as the hubs 22 are constructed of a closed-cell foam material, neither the fingers 16 nor the hubs 22 absorb water or entrap debris and dirt on their surface. Consequently, the carwash brush 10 of the present invention effectively precludes damage to the finish on the vehicles 20 during the carwash operation.

A still further advantage of the present invention is that the brush may be inexpensively manufactured and yet is durable in operation.

Having described my invention, however, many modifications thereto will become apparent to those skilled in the art to which it pertains without deviation from the spirit of the invention as defined by the scope of the appended claims.

I claim:

1. A carwash brush comprising:
a pair of annular hubs, each hub having a planar axial surface,
a plurality of elongated fingers, each finger having a first end positioned between and annularly around said axial surfaces of said hubs so that a second end of each said finger extends radially outwardly from said hubs, said second ends of said fingers being circumferentially spaced from each other,
wherein said first ends of said fingers are continuously bonded to said hubs.

2. The invention as defined in claim 1 wherein said first ends of said fingers are adhesively bonded to said hubs.

3. The invention as defined in claim 1 wherein said fingers are constructed of a foam material.

4. The invention as defined in claim 3 wherein said foam material is a closed-cell foam material.

5. The invention as defined in claim 1 wherein said hubs are constructed of a foam material.

6. The invention as defined in claim 5 wherein said foam material is a closed-cell foam material.

7. The invention as defined in claim 1 wherein each finger comprises two spaced apart and planar surfaces, said planar surfaces of said fingers being in abutment with said planar axial surfaces of said hubs.

8. The invention as defined in claim 7 and comprising an outwardly extending projection on one side of each said finger adjacent said first end of each said finger and a recess having a shape complementary to said projection on the other side of each said finger adjacent said first end of each said finger, wherein said projection on one finger nests within the recess on the adjacent finger.

9. The invention as defined in claim 8 wherein said fingers and said projections are of a one-piece construction.

10. The invention as defined in claim 8 wherein said first ends of said fingers form a continuous annular surface between said hubs.

11. The invention as defined in claim 1 wherein said first ends of said fingers form a continuous annular surface between said hubs.

12. The invention as defined in claim 1 and comprising a plurality of spaced apart hubs, each pair of adjacent hubs having a plurality of said fingers sandwiched therebetween.

13. The invention as defined in claim 8 wherein said projections are V-shaped.

14. The invention as defined in claim 1 and comprising a plurality of layers of said fingers sandwiched between two said hubs.
